(19) United States
(12) Patent Application Publication
(10) Pub. No.: US 2023/0194687 A1
(43) Pub. Date: Jun. 22, 2023

(54) OPTICAL AXIS CORRECTION METHOD, OPTICAL AXIS CORRECTION DEVICE, AND STORAGE MEDIUM

(71) Applicant: TOYOTA JIDOSHA KABUSHIKI KAISHA, Toyota-shi Aichi-ken (JP)

(72) Inventor: Yusuke KATAOKA, Toyota-shi Aichi-ken (JP)

(73) Assignee: TOYOTA JIDOSHA KABUSHIKI KAISHA, Toyota-shi Aichi-ken (JP)

(21) Appl. No.: 17/985,197

(22) Filed: Nov. 11, 2022

(30) Foreign Application Priority Data
Dec. 20, 2021 (JP) 2021-205909

(51) Int. Cl. G01S 7/497; G01S 17/931

(52) U.S. Cl. CPC G01S 7/497; G01S 17/931

(57) ABSTRACT

The present disclosure relates to an optical axis correction method for performing an optical axis correction of a surrounding environment recognition sensor mounted on a vehicle and including a pair of sensors configured of a first sensor in a first direction of the vehicle and a second sensor in a second direction symmetrical to the first direction. The method includes: detecting, with the sensors, a pair of objects located respectively in the first direction and the second direction; acquiring a first road surface angle in the first direction and a second road surface angle in the second direction with the sensors; acquiring a first object angle in the first direction, and a second object angle in the second direction; and restricting the optical axis correction when the first and the second road surface angles do not match, or when the first and second object angles do not match.

### CROSS-REFERENCE TO RELATED APPLICATION

This application claims priority to Japanese Patent Application No. 2021-205909 filed on Dec. 20, 2021, incorporated herein by reference in its entirety.

### BACKGROUND

### 1. Technical Field

The present disclosure relates to a technique for performing optical axis correction of a surrounding environment recognition sensor mounted on a vehicle.

### 2. Description of Related Art

Japanese Unexamined Patent Application Publication No. 2008-203147 (JP 2008-203147 A) discloses an on-vehicle radar with an axis adjustment function for adjusting an axis of a radio wave radiation direction. The on-vehicle radar dynamically corrects the radio wave radiation axis so as to maximize a reception intensity from a target.

### SUMMARY

As disclosed in Japanese Unexamined Patent Application Publication No. 2008-203147 (JP 2008-203147 A), there is known a technique for dynamically correcting an optical axis of a surrounding environment recognition sensor such as an in-vehicle radar. The dynamic correction is to perform an optical axis correction with objects located around a vehicle set as targets, while the vehicle is in steady operation. The dynamic correction allows correction without the need for highly efficient reflectors or large spaces for correction. However, in the dynamic correction, instead of being able to perform correction at an arbitrary location, a road gradient difference may occur between the vehicle and the object that is the target. In a situation where there is a difference in road surface gradient, if correction is performed based on the angle of the object that is the target, the optical axis will be corrected in the wrong direction.

An object of the present disclosure is to provide a technology that suppress correction in a wrong direction due to a difference in a road surface gradient when dynamically correcting an optical axis of a surrounding environment recognition sensor.

A first aspect relates to an optical axis correction method of a surrounding environment recognition sensor mounted on a vehicle. The surrounding environment recognition sensor includes a pair of sensors configured of a first sensor provided in a first direction of the vehicle and a second sensor provided in a second direction symmetrical to the first direction. The optical axis correction method includes: detecting, with the pair of sensors, a pair of objects located respectively in the first direction and the second direction; performing the optical axis correction with the pair of objects set as targets; acquiring, with the pair of sensors, a first road surface angle that is an angle of a road surface in the first direction with respect to the first direction, and a second road surface angle that is an angle of a road surface in the second direction with respect to the first direction; acquiring a first object angle that is an angle of an obj ect in the first direction with respect to the first direction, and a second object angle that is an angle of an object in the second direction with respect to the second direction; and restricting the optical axis correction when the first road surface angle and the second road surface angle do not match, or when the first object angle and the second object angle do not match.

A second aspect relates to an optical axis correction device of a surrounding environment recognition sensor mounted on a vehicle. The surrounding environment recognition sensor includes a pair of sensors provided in a first direction of the vehicle and a second direction symmetrical to the first direction. The optical axis correction device is configured to execute: a process of detecting, with the pair of sensors, a pair of objects located respectively in the first direction and the second direction; a process of performing the optical axis correction with the pair of objects set as targets; a process of acquiring, with the pair of sensors, a first road surface angle that is an angle of a road surface in the first direction with respect to the first direction, and a second road surface angle that is an angle of a road surface in the second direction with respect to the first direction; a process of acquiring a first object angle that is an angle of an object in the first direction with respect to the first direction, and a second object angle that is an angle of an object in the second direction with respect to the second direction; and a process of restricting the optical axis correction when the first road surface angle and the second road surface angle do not match, or when the first object angle and the second object angle do not match.

A third aspect relates to a storage medium that stores a program executed by a computer. The program causes the computer to execute the optical axis correction method according to the first aspect.

According to the present disclosure, when dynamically correcting an optical axis of a surrounding environment recognition sensor mounted on a vehicle, it is possible to suppress the optical axis from being corrected in a wrong direction due to a road surface gradient difference.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a conceptual diagram showing a scene in which optical axis correction is performed in an optical axis correction method according to the present embodiment;

FIG. 1B is a conceptual diagram showing a scene in which optical axis correction is performed in an optical axis correction method according to the present embodiment;

FIG. 2A is a conceptual diagram showing a scene in which the optical axis correction is restricted in the optical axis correction method according to the present embodiment;

FIG. 2B is a conceptual diagram showing a scene in which the optical axis correction is restricted in the optical axis correction method according to the present embodiment;

FIG. 3 is a conceptual diagram showing a case where a first direction and a second direction represent a right side and a left side in the optical axis correction method according to the present embodiment;

FIG. 4 is a conceptual diagram showing a case where the first direction and the second direction represent forward and rearward in the optical axis correction method according to the present embodiment;

FIG. 5 is a block diagram showing a configuration example of a vehicle according to the present embodiment;

FIG. 6 is a flowchart showing an example of a process when the first direction and the second direction are the right side and the left side in the optical axis correction method according to the present embodiment;

FIG. 7 is a flowchart showing an example of a process when the first direction and the second direction are forward and rearward in the optical axis correction method according to the present embodiment;

FIG. 8 is a conceptual diagram for explaining a modified example of the optical axis correction method according to the present embodiment; and

FIG. 9 is a flowchart showing an example of a process related to the modified example of the optical axis correction method according to the present embodiment.

### DETAILED DESCRIPTION OF EMBODIMENTS

Embodiments of the present disclosure will be described with reference to the accompanying drawings.

### 1. Overview

An optical axis correction method according to the present embodiment is a method for correcting an optical axis of a surrounding environment recognition sensor mounted on a vehicle. The vehicle may be an autonomous vehicle. A surrounding environment recognition sensor is a sensor for recognizing the situation around the vehicle among sensors mounted on the vehicle, and includes, for example, a millimeter wave radar, a sonar, and a camera. The optical axis of the surrounding environment recognition sensor may deviate due to factors such as vehicle vibration and loose parts. Continuing to drive with the optical axis deviated may suppress the vehicle from accurately recognizing the surroundings and hinder safe driving. Thus, it is necessary to correct the optical axis of the surrounding environment recognition sensor at the timing when the deviation of the optical axis is detected or every time a certain period of time elapses. In the present embodiment, the optical axis correction is performed dynamically, that is, while the vehicle is in steady operation, such as when the vehicle is traveling. With the dynamic optical axis correction, the optical axis correction can be performed without preparing a dedicated reflector or a large space. The dynamic optical axis correction may be done by physically adjusting the angles of the components, or by processing inside the sensor (for example, beamforming).

In this embodiment, the surrounding environment recognition sensor includes a pair of sensors provided in a first direction of the vehicle and a second direction symmetrical with the first direction. For example, the pair of sensors is a sensor provided on the left side of the vehicle and a sensor provided on the right side of the vehicle. Alternatively, the pair of sensors is a sensor provided in front of the vehicle and a sensor provided in the rear of the vehicle. A sensor provided in the first direction is called a first sensor, and a sensor provided in the second direction is called a second sensor.

In the dynamic optical axis correction, the optical axis is corrected with the object detected by the surrounding environment recognition sensor set as the target. For example, an object having a reflecting surface perpendicular to a road surface is detected, and the optical axis is corrected so as to be perpendicular to the reflecting surface of the object. The object for the optical axis correction need not be set in advance, and any object can be used. However, some objects are suitable for the optical axis correction and some are not. For example, objects that do not have a reflective surface with a constant angle, such as pedestrians and roadside trees, are not suitable objects for the optical axis correction. Conversely, an object that can be expected to have a reflective surface with a certain angle is suitable as an object for the optical axis correction. Examples include utility poles, fences, highway walls, and adjacent vehicles. Whether an object is suitable as a target for the optical axis correction can be determined from the reflected light acquired by the surrounding environment recognition sensor. In the optical axis correction method according to the present embodiment, when the optical axis correction becomes necessary, a process for detecting an object is performed, and the optical axis correction is performed based on the angle of the detected object.

Here, even when an object is detected, a road surface gradient of a road surface on which the vehicle travels and a road surface gradient of a road surface on which the object is located are not always equal. Hereinafter, it is assumed that there is no road surface gradient difference when the road surface gradient of the road surface on which the vehicle is traveling is equal to the road surface gradient of the road surface on which the object is located. When the optical axis is corrected based on the angle of the object in a scene where there is a road surface slope difference, the optical axis is corrected in the wrong direction. Thus, the optical axis correction is required to be performed in a state where there is no road surface slope difference.

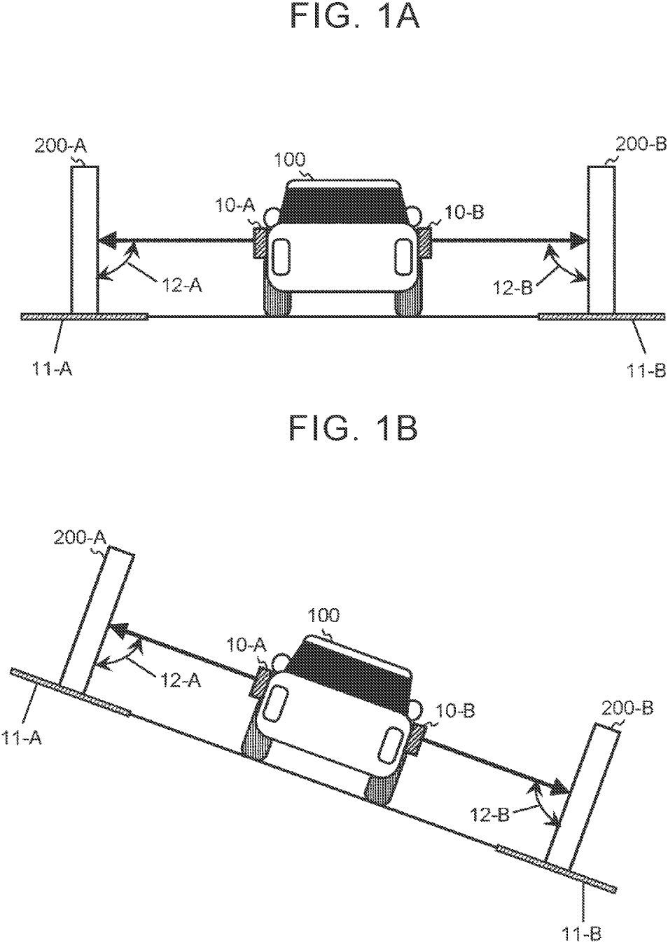

FIG. 1A and FIG. 1B conceptually illustrate an example of a vehicle state when there is no road gradient difference. A vehicle 100 includes a first sensor 10-A and a second sensor 10-B, which are a pair of sensors, as a surrounding environment recognition sensor. The first sensor 10-A detects an object 200-A in the first direction, and the second sensor 10-B detects an object 200-B in the second direction. Also, the first sensor 10-A can acquire a first road surface angle 11-A and a first object angle 12-A. The second sensor 10-B can acquire a second road surface angle 11-B and a second object angle 12-B. The first road surface angle 11-A is an angle of a road surface in the first direction with respect to the first direction, and the second road surface angle 11-B is an angle of a road surface in the second direction with respect to the first direction. The first object angle 12-A is the angle of the object 200-A in the first direction with respect to the first direction, and the second object angle 12-B is the angle of the object 200-B in the second direction with respect to the second direction.

In order to suppress the optical axis from being corrected in the wrong direction, it is necessary to confirm that there is no road surface gradient difference before performing the optical axis correction. Here, as in (1), when the optical axis correction is performed only when both the road surface on which the vehicle 100 is traveling and the road surface on which the object is located are horizontal, it is sufficient that the optical axis correction is performed when it is confirmed that the first road surface angle 11-A and the second road surface angle 11-B are both horizontal. However, in reality, as in (2), there is a case in which although the road surface on which the object is located has a road surface gradient, the road surface gradient is equal to that of the road surface on which the vehicle is traveling, so there is no road surface gradient difference. Ideally, the optical axis can be corrected even in situations such as (2). Here, when the surrounding environment recognition sensor can acquire information about the gradient of the road surface on which the vehicle is traveling, the gradient of the road surface on which the vehicle is traveling and the gradient of the road surface on which the object is located should be directly compared. However, there is a limit to the range of the road surface from which the surrounding environment recognition sensor can acquire information about the gradient. For example, when the surrounding environment recognition sensor is oriented horizontally with respect to the vehicle, the surrounding environment recognition sensor cannot acquire information about the slope of the road surface directly below the vehicle.

Thus, the optical axis correction method according to the present embodiment includes acquiring the first road surface angle 11-A and the second road surface angle 11-B. When the first road surface angle 11-A and the second road surface angle 11-B do not match, there is a road surface gradient difference between the road surface on which the vehicle travels and at least one of the road surface in the first direction and the road surface in the second direction. Thus, the optical axis correction method according to the present embodiment includes restricting the optical axis correction when the first road surface angle 11-A and the second road surface angle 11-B do not match.

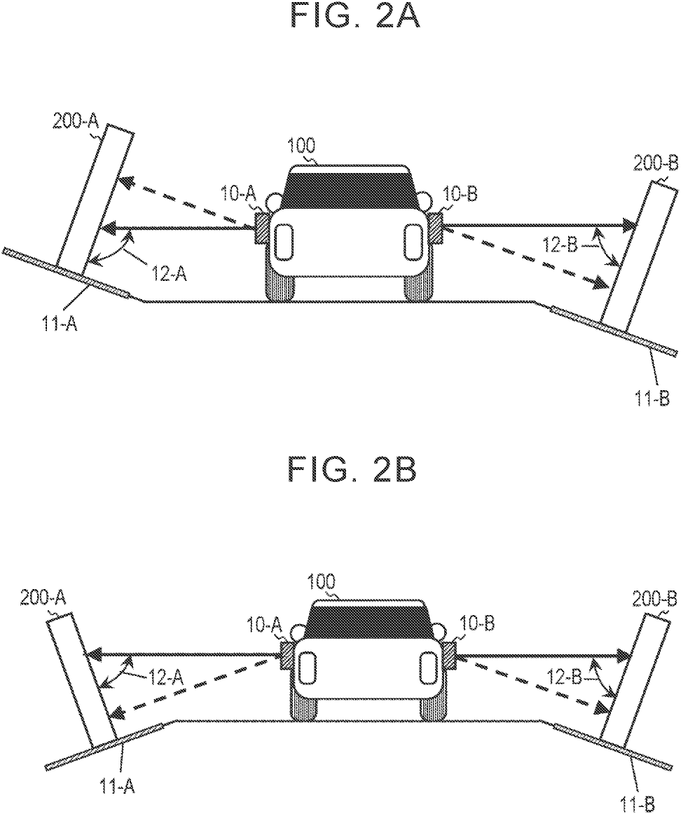

However, simply confirming that the first road surface angle 11-A and the second road surface angle 11-B match is still insufficient. FIG. 2A and FIG. 2B conceptually show an example of a state where there is a road surface gradient difference. For example, as shown in FIG. 2A, the first road surface angle 11-A and the second road surface angle 11-B may match even when there is a road surface gradient difference. When the optical axis correction is performed in such a state, correction is performed in the wrong direction as indicated by the dotted arrow. In order to suppress such a situation, the optical axis correction method according to the present embodiment further includes restricting the optical axis correction when the first object angle 12-A and the second object angle 12-B do not match. As shown in FIG. 2A, in a case in which the road surface gradient of the road surfaces on which the object 200-A in the first direction and the object 200-B in the second direction are located and there is a road surface gradient difference between the road surface on which the vehicle travels and the road surfaces on which the object 200-A in the first direction and the object 200-B in the second direction are located, the first object angle 12-A and the second object angle 12-B do not match and thus, it is possible to suppress erroneous optical axis correction from being performed.

Here, it is not enough to limit the optical axis correction only when the first object angle 12-A and the second object angle 12-B do not match. This is because, as shown in FIG. 2B, there may be a situation where the first object angle 12-A and the second object angle 12-B match even though there is a difference in the road surface gradient. Thus, when the first road surface angle 11-A and the second road surface angle 11-B or the first object angle 12-A and the second object angle 12-B do not match, restricting the optical axis correction of the surrounding environment recognition sensor is an appropriate method of suppressing the optical axis correction in the wrong direction.

Thus, the optical axis correction method according to the present embodiment acquires the first road surface angle 11-A, the second road surface angle 11-B, the first object angle 12-A, and the second object angle 12-B. Then, when the first road surface angle 11-A and the second road surface angle 11-B do not match, the optical axis correction of the surrounding environment recognition sensor is restricted. Further, even when the first object angle 12-A and the second object angle 12-B do not match, the optical axis correction of the surrounding environment recognition sensor is restricted. The optical axis correction method according to the present embodiment can thus suppress erroneous correction due to the road surface gradient difference from being executed. As shown in FIG. 1A and FIG. 1B, in a state where there is no gradient difference, since the first road surface angle 11-A and the second road surface angle 11-B match, and the first object angle 12-A and the second object angle 12-B match, the optical axis correction can be performed. In this way, the optical axis correction is not restricted more than necessary.

### 2. Specific Example

Although the first direction and the second direction may be any directions, it is most suitable that the first direction and the second direction are the right and left sides of the vehicle or the front and rear. In this case, the optical axis correction method according to this embodiment can be applied to existing sensors. For example, sensors used for a lane tracing function, a cruise control function, etc. are often provided in the right-left direction and the front-rear direction of the vehicle. Furthermore, when the first direction and the second direction are the right side and the left side of the vehicle, or the front and the rear, there are many objects that are paired in the first direction and the second direction. For example, highway walls, utility poles, and the like often exist in pairs on the right and left sides of the vehicle. In addition, adjacent vehicles often exist in front of and behind the vehicle at the same time. Thus, many objects can be appropriately used as objects for optical axis correction.

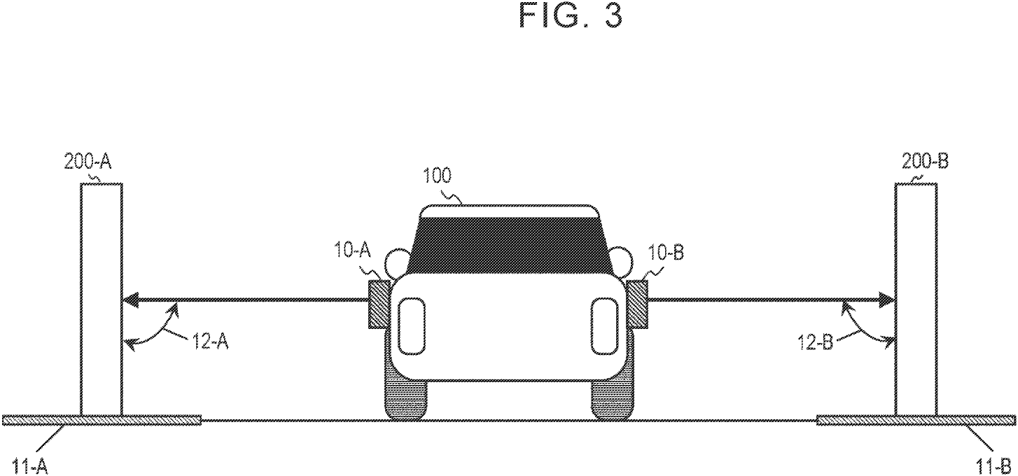

FIG. 3 shows an example in which the first direction is the right side and the second direction is the left side. The vehicle 100 includes the first sensor 10-A for the right direction and the second sensor 10-B for the left direction. A first sensor 10-A in the right direction acquires a first road surface angle 11-A in the right direction and a first object angle 12-A in the right direction. The second sensor 10-B in the left direction acquires the second road surface angle 11-B in the left direction and the second object angle 12-B in the left direction. In the example of FIG. 3, the first road surface angle 11-A in the right direction and the second road surface angle 11-B in the left direction match, and the first object angle 12-A in the right direction and the second object angle 12-B in the left direction match. Thus, the optical axis correction is not limited in the scene illustrated in FIG. 3.

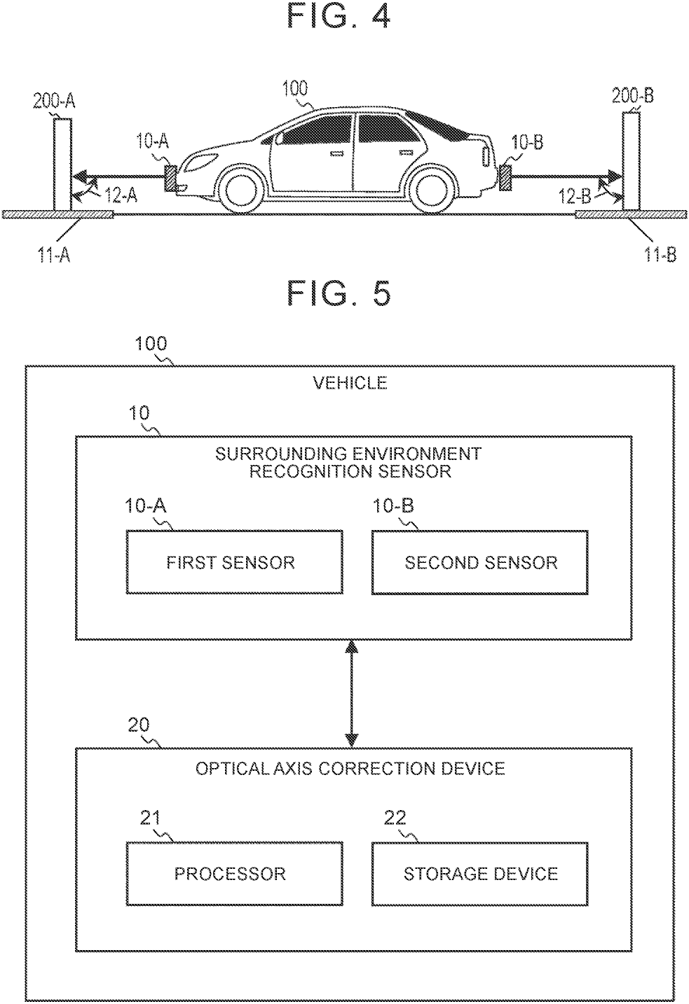

FIG. 4 is an example in which the first direction is the forward direction and the second direction is the rearward direction. The vehicle 100 includes the first sensor 10-A in the front direction and the second sensor 10-B in the rear direction. The first sensor 10-A in the front direction acquires the first road surface angle 11-A in the front direction and the first object angle 12-A in the front direction. The second sensor 10-B in the rearward direction acquires the second road surface angle 11-B in the rearward direction and the second object angle 12-B in the rearward direction. In the example of FIG. 4, the first road surface angle 11-A in the front direction and the second road surface angle 11-B in the rear direction match, and the first object angle 12-A in the front direction and the second object angle 12-B in the rear direction match. Thus, the optical axis correction is not restricted in the scene illustrated in FIG. 4.

### 3. Configuration Example

FIG. 5 is a block diagram showing a configuration example of the vehicle 100 that implements the optical axis correction method according to the present embodiment. The vehicle 100 includes a surrounding environment recognition sensor 10 and an optical axis correction device 20. The surrounding environment recognition sensor 10 and the optical axis correction device 20 are configured to be able to communicate with each other via an in-vehicle network or the like. The surrounding environment recognition sensor 10 includes the first sensor 10-A and the second sensor 10-B. The optical axis correction device 20 includes a processor 21 and a storage device 22. The storage device 22 is an example of a storage medium. The processor 21 executes a program stored in the storage device 22 to implement a processing unit (hereinafter also referred to as an “optical axis correction execution determination unit”) that determines whether to limit the optical axis correction.

Although not shown in FIG. 5, the surrounding environment recognition sensor 10 may include a processor, a storage device, and a recognition output unit. Alternatively, the first sensor 10-A and the second sensor 10-B may each include a processor, a storage device, and a recognition output unit. Information about the road surface angle and the object angle acquired by each sensor is sent to the processor 21 via the recognition output unit.

The surrounding environment recognition sensor 10 detects objects in the first direction and the second direction while the vehicle is in steady operation. When it is determined that optical axis correction is necessary, the surrounding environment recognition sensor 10 detects the first road surface angle 11-A, the second road surface angle 11-B, the first object angle 12-A, and the second object angle 12-B. It may be the processor 21 or the processor of the surrounding environment recognition sensor 10 that determines that the optical axis correction is necessary. Each acquired angle is transmitted to the optical axis correction device 20. The processor 21 determines whether the first road surface angle 11-A and the second road surface angle 11-B match and whether the first object angle 12-A and the second object angle 12-B match, based on the transmitted angles. When either does not match, the processor 21 limits the optical axis correction of the surrounding environment recognition sensor 10. When the optical axis correction is not restricted, the optical axis correction device 20 performs the optical axis correction of the first sensor 10-A and the second sensor 10-B with the object detected as necessary set as the target. However, the processing related to the optical axis correction may be configured to be executed by a processor included in the surrounding environment recognition sensor 10. In this case, the processor of the surrounding environment recognition sensor 10 executes a program stored in the storage device, thereby realizing a processing unit (hereinafter also referred to as an “optical axis correction unit”) that executes the optical axis correction. The optical axis correction unit performs the optical axis correction of the first sensor 10-A and the second sensor 10-B.

### 4. Process Flow

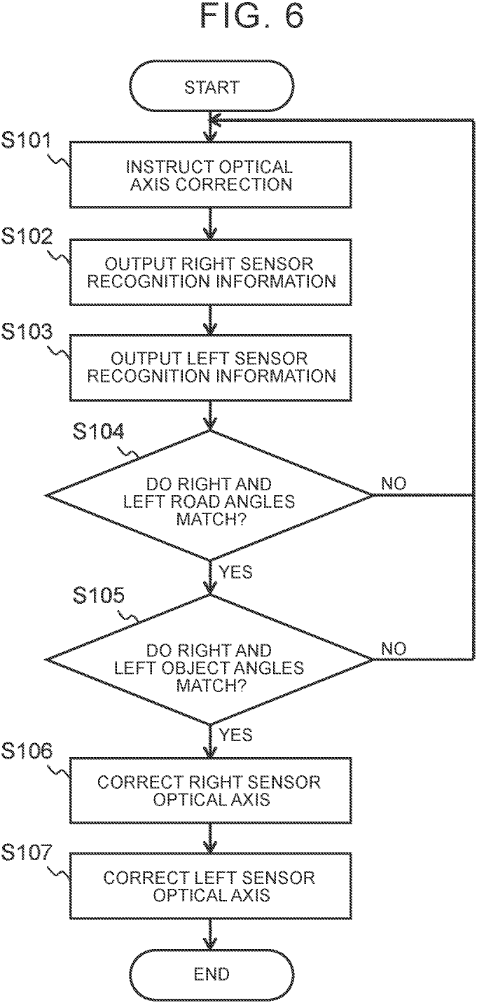

FIG. 6 is a flowchart showing an example of a process when the first direction is the right side and the second direction is the left side in the optical axis correction method according to the present embodiment. The flowchart illustrated in FIG. 6 is executed by processor 21.

In step S101, the processor 21 is instructed to correct the optical axis. An optical axis correction instruction is issued by the processor of the surrounding environment recognition sensor 10, for example, in response to detecting that it is necessary to correct the optical axis. When the processor 21 receives the optical axis correction instruction, the process proceeds to step S102.

In step S102, information about the first road surface angle 11-A in the right direction and the first object angle 12-A in the right direction is output from the recognition output unit of the right side first sensor 10-A. When the processor 21 receives the output information, the process proceeds to step S103.

In step S103, information about the second road surface angle 11-B in the left direction and the second object angle 12-B in the left direction is output from the recognition output unit of the left side second sensor 10-B. When the processor 21 receives the output information, the process proceeds to step S104.

In step S104, it is determined whether the first road surface angle 11-A in the right direction and the second road surface angle 11-B in the left direction match. When the road surface angles match (step S104; Yes), the process proceeds to step S105. When the road surface angles do not match (step S104; No), the process returns to step S101.

In step S105, it is determined whether the first object angle 12-A in the right direction and the second object angle 12-B in the left direction match. When the object angles match (step S105; Yes), the process proceeds to step S106. When the object angles do not match (step S105; No), the process returns to step S101. The determinations in steps S104 and S105 are made in the optical axis correction execution determination unit.

In step S106, an instruction to correct the optical axis is issued to the optical axis correction unit of the first sensor 10-A in the right direction. In response to the instruction, the optical axis correction unit performs a process for correcting the optical axis in a vehicle height direction. After that, the process proceeds to step S107.

In step S107, an instruction to perform the optical axis correction is issued to the optical axis correcting unit of the second sensor 10-B in the left direction. In response to the instruction, the optical axis correction unit performs a process for correcting the optical axis in a vehicle height direction. After that, the process ends.

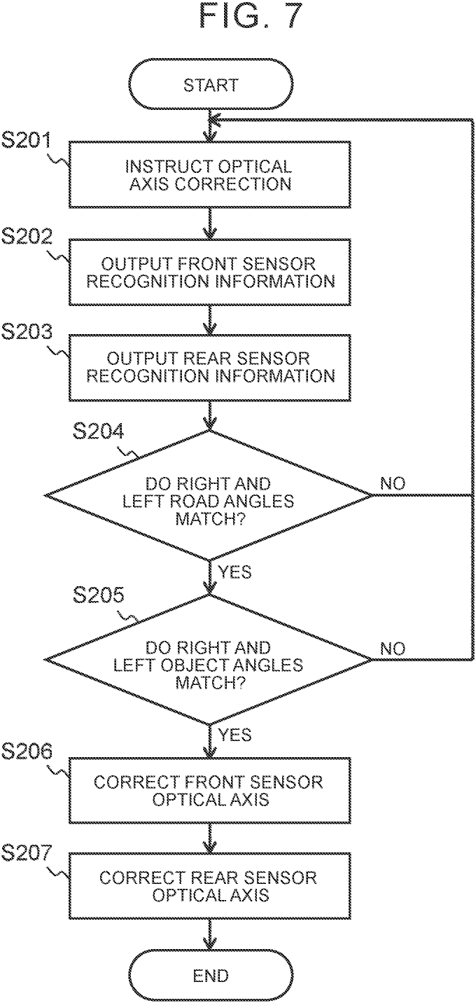

FIG. 7 is a flowchart showing an example of a process when the first direction is the forward direction and the second direction is the rearward direction in the optical axis correction method according to the present embodiment. The flowchart illustrated in FIG. 7 is executed by processor 21.

In step S201, the same processing as in step S101 of FIG. 6 is performed. When the processor 21 receives the optical axis correction instruction, the process proceeds to step S202.

In step S202, information about the first road surface angle 11-A in the front direction and the first object angle 12-A in the rear direction is output from the recognition output unit of the first sensor 10-A in the front direction. When the processor 21 receives the output information, the process proceeds to step S203.

In step S203, information about the second road surface angle 11-B in the rear direction and the second object angle 12-B in the rear direction is output from the recognition output unit of the second sensor 10-B in the rear direction. When the processor 21 receives the output information, the process proceeds to step S204.

In step S204, it is determined whether the first road surface angle 11-A in the front direction and the second road surface angle 11-B in the rear direction match. When the road surface angles match (step S204; Yes), the process proceeds to step S205. When the road surface angles do not match (step S204; No), the process returns to step S201.

In step S205, it is determined whether the first object angle 12-A in the front direction and the second object angle 12-B in the rear direction match. When the object angles match (step S205; Yes), the process proceeds to step S206. When the object angles do not match (step S205; No), the process returns to step S201. The determinations in steps S204 and S205 are made in the optical axis correction execution determination unit.

In step S206, an instruction to perform the optical axis correction is issued to the optical axis correction unit of the first sensor 10-A in the front direction. In response to the instruction, the optical axis correction unit performs a process for correcting the optical axis in a vehicle height direction. After that, the process proceeds to step S207.

In step S207, an instruction to perform the optical axis correction is issued to the optical axis correcting unit of the second sensor 10-B in the rear direction. In response to the instruction, the optical axis correction unit performs a process for correcting the optical axis in a vehicle height direction. After that, the process ends.

### 5. Modified Example

Due to the processes illustrated in the flowcharts in FIGS. 6 and 7, when the road surface gradients of the road surface on which the object 200-A in the first direction is located, the road surface on which the object 200-B in the second direction is located, and the road surface on which the vehicle travels do not match, the optical axis correction is restricted. However, even when the optical axis correction is restricted in the process illustrated in the flowchart of FIGS. 6 and 7, there is a case in which the road surface angle of the road surface on which the vehicle travels matches with one of the road surface on which the object 200-A in the first direction is located or the road surface on which the object 200-B in the second direction is located. In a modified example, it is possible to perform the optical axis correction even in such a situation. In the optical axis correction method according to the modified example even when either the first road surface angle 11-A and the second road surface angle 11-B or the first object angle 12-A and the second object angle 12-B do not match, the restriction is lifted under certain conditions. Specifically, when a state in which the road surface angle acquired by either the first sensor 10-A or the second sensor 10-B is horizontal and the object angle is vertical continues for a predetermined period of time, the restriction on the optical axis correction for the sensor is lifted. The restriction is lifted for a single sensor that satisfies the conditions, and the optical axis correction can be performed.

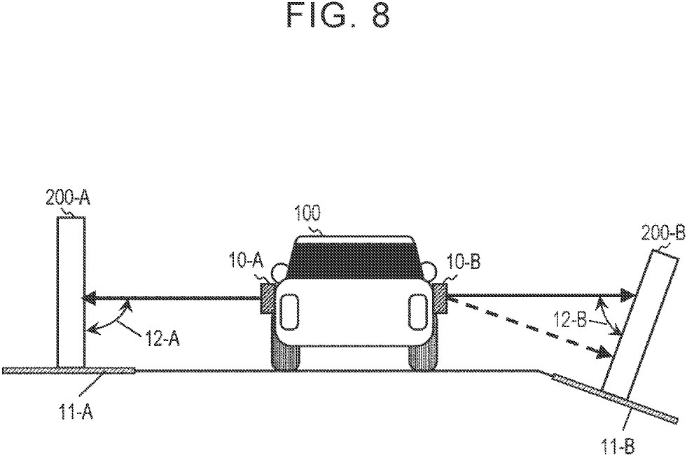

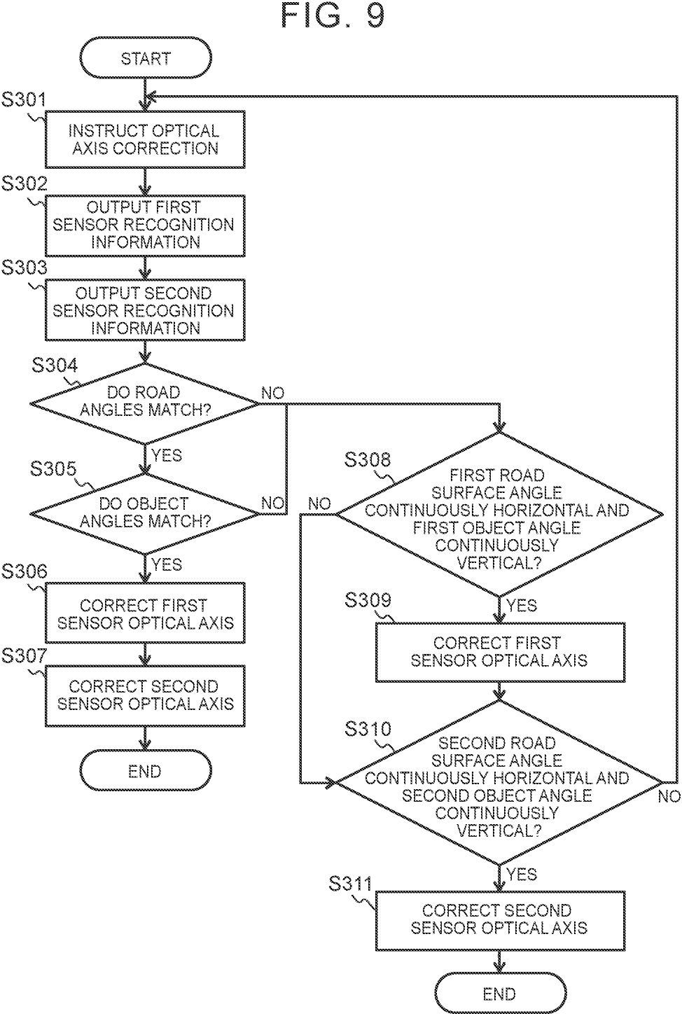

In the modified example, the restriction on the optical axis correction is lifted for a single sensor, for example, as shown in FIG. 8. In the example of FIG. 8, the first road surface angle 11-A and the second road surface angle 11-B do not match, and the first object angle 12-A and the second object angle 12-B do not match. However, for the first direction, the first road surface angle 11-A is horizontal and the first object angle 12-A is vertical. Thus, in the first direction, even when the optical axis is corrected in accordance with the angle of the object, the correction will not be erroneous. Thus, when a state in which the road surface angle is horizontal and the object angle is vertical is continued for a predetermined time or longer, the restriction on the optical axis correction is lifted only for the continuous direction. As a result, even when the angles of the road surface and the object do not match between the first direction and the second direction, the optical axis correction can be performed for the sensors in the directions where there is no difference in the road surface gradient.

FIG. 9 is a flowchart showing an example of a process in the modified example. The processes from step S301 to step S307 is the same processes as steps S101 to S107 in FIG. 6 and steps S201 to S207 in FIG. 7. When the road surface angle and the object angle do not match between the first direction and the second direction, the optical axis corrections in steps S306 and S307 are not performed. However, in the flowchart of FIG. 9, when the road surface angles do not match in step S304 (step S304; No), the process proceeds to step S308. Also, when the object angles do not match in step S305 (step S305; No), the process proceeds to step S308.

In step S308, it is determined whether the state in which the road surface angle is horizontal and the object angle is vertical has continued for a predetermined time or longer with respect to the information acquired by the first sensor 10-A. When the road surface angle is horizontal and the object angle is vertical for the predetermined time or longer (step S308; Yes), the process proceeds to step S309. When the road surface angle is not horizontal or the object angle is not vertical, or when the state where the road surface angle is horizontal and the object angle is vertical is ended within the predetermined time (step S308; No), the process proceeds to step S310.

In step S309, the optical axis correction unit of the first sensor is instructed to perform the optical axis correction. In response to the instruction, the optical axis correction unit performs a process for correcting the optical axis in a vehicle height direction. The process then proceeds to step S310.

In step S310, it is determined whether the state in which the road surface angle is horizontal and the object angle is vertical has continued for a predetermined time or longer with respect to the information acquired by the second sensor 10-B. When the road surface angle is horizontal and the object angle is vertical for the predetermined time or longer (step S310; Yes), the process proceeds to step S311. When the road surface angle is not horizontal or the object angle is not vertical, or when the state where the road surface angle is horizontal and the object angle is vertical is ended within the predetermined time (step S310; No), the process returns to step S301.

In step S311, the optical axis correction unit of the second sensor is instructed to perform the optical axis correction. In response to the instruction, the optical axis correction unit performs a process for correcting the optical axis in a vehicle height direction. After that, the process ends.

In the modified example, even when the road surface angle and the object angle do not match between the first direction and the second direction, in at least one of the first direction and the second direction, when the state where the road surface angle is horizontal and the object angle is vertical continues for a predetermined time or longer, the restriction on the optical axis correction is lifted for the continued direction. Thereby, the optical axis correction can be performed for at least a single sensor.

### 6. Summary

As described above, in the optical axis correction method according to the present embodiment, when the first road surface angle and the second road surface angle do not match, or when the first object angle and the second object angle do not match, the optical axis correction is restricted. As a result, in the dynamic optical axis correction of the surrounding environment recognition sensor, it is possible to suppress correction in the wrong direction due to the difference in the road surface gradient. Further, in at least one of the first direction and the second direction, when the state where the road surface angle is horizontal and the object angle is vertical continues for a predetermined time or longer, the restriction on the optical axis correction is lifted for the continued direction. Accordingly, in a situation where the optical axis correction can be performed for a single sensor, the optical axis correction can be performed for a single sensor.

What is claimed is:

1. An optical axis correction method for performing an optical axis correction of a surrounding environment recognition sensor mounted on a vehicle,
the surrounding environment recognition sensor including a pair of sensors configured of a first sensor provided in a first direction of the vehicle and a second sensor provided in a second direction symmetrical to the first direction,
the optical axis correction method comprising:
detecting, with the pair of sensors, a pair of objects located respectively in the first direction and the second direction;
performing the optical axis correction with the pair of objects set as targets;
acquiring, with the pair of sensors, a first road surface angle that is an angle of a road surface in the first direction with respect to the first direction, and a second road surface angle that is an angle of a road surface in the second direction with respect to the first direction;
acquiring a first object angle that is an angle of an object in the first direction with respect to the first direction, and a second object angle that is an angle of an object in the second direction with respect to the second direction; and
restricting the optical axis correction when the first road surface angle and the second road surface angle do not match, or when the first object angle and the second object angle do not match.

2. The optical axis correction method according to claim 1, further comprising:
lifting a restriction on the optical axis correction of the first sensor when a state in which the first road surface angle is horizontal and the first object angle is vertical is continued for a predetermined time or longer; and
lifting the restriction on the optical axis correction of the second sensor when a state in which the second road surface angle is horizontal and the second object angle is vertical is continued for a predetermined time or longer.

3. The optical axis correction method according to claim 1, wherein the first direction and the second direction are a right side and a left side or a front side and a rear side.

4. An optical axis correction device that performs an optical axis correction of a surrounding environment recognition sensor mounted on a vehicle,
the surrounding environment recognition sensor including a pair of sensors provided in a first direction of the vehicle and a second direction symmetrical to the first direction, and
the optical axis correction device being configured to execute:
a process of detecting, with the pair of sensors, a pair of objects located respectively in the first direction and the second direction;
a process of performing the optical axis correction with the pair of objects set as targets;
a process of acquiring, with the pair of sensors, a first road surface angle that is an angle of a road surface in the first direction with respect to the first direction, and a second road surface angle that is an angle of a road surface in the second direction with respect to the first direction;
a process of acquiring a first object angle that is an angle of an object in the first direction with respect to the first direction, and a second object angle that is an angle of an object in the second direction with respect to the second direction; and
a process of restricting the optical axis correction when the first road surface angle and the second road surface angle do not match, or when the first object angle and the second object angle do not match.

5. A non-transitory storage medium that stores a program that is executed by a computer and that causes the computer to execute the optical axis correction method according to claim 1.
